(19) United States
(12) Patent Application Publication
(10) Pub. No.: US 2009/0035169 A1
(43) Pub. Date: Feb. 5, 2009

(54) Dual metal torque transmitting apparatuses and methods for making the same

(75) Inventors: Christopher Wayne Vaughn, Mebane, NC (US); Andrew Joseph McDaniel, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Honda Motor Co., Ltd.

(21) Appl. No.: 11/890,178

(22) Filed: Aug. 3, 2007

(51) Int. Cl. B22F 3/14; F16D 9/00; F16H 35/10

(52) U.S. Cl. 419/53; 464/32; 74/640

(57) ABSTRACT

Apparatuses and methods are provided for transmitting torque in a way that can prolong the life of such apparatuses by using dissimilar materials for a body region and a torque transmitting region that absorbs the wear of the apparatuses, the apparatuses being constructed by methods of powder metallurgy. A torque transmitting apparatus can be provided and can include an annular body member composed of a first material and an outer ring member composed of a second powder metal material. The outer ring member can shrink about the annular body member during a sintering phase to form a single body in which the outer ring member can be fixedly attached to the annular body member.

### TECHNICAL FIELD

The subject matter disclosed herein relates generally to apparatuses for transmitting torque and methods for making the same. More particularly, the present subject matter relates to dual metal torque transmitting apparatuses that can have a body member and an outer member constructed of a powder metal material that provides improved wear resistance.

### BACKGROUND

Torque transmitting apparatuses such as gears, sprockets, clutch disks, friction plates, etc., are used in a myriad of applications including internal combustion engines, bicycles, and other machinery. These apparatuses must withstand various load requirements during use that can cause tremendous amounts of wear thereon. For example, a timing system in an internal combustion engine can include two sprockets, a camshaft sprocket and a crankshaft sprocket, with teeth for engaging a metal link chain. The crankshaft sprocket drives the chain which in turn applies torque to the camshaft sprocket, thereby turning it in unison. The camshaft sprocket is significantly larger than the crankshaft sprocket to effect a reduction in speed. The engagement of the teeth with the chain significantly wears on the sprockets such that replacement sprockets are frequently needed in many applications.

Previously, torque transmitting apparatuses comprised of metals have been constructed by metal stamping, machine casting, and powder metallurgy. The strength and wear resistance needed from these apparatuses requires that the apparatuses be constructed with high precision and endurance. Powder metallurgy facilitates the manufacture of these torque transmitting apparatuses to have the aforementioned characteristics. In powder metallurgy, a powder metal is pressed and compacted into a preformed shape and then thermally treated in a process referred to as sintering that forms a cured body.

Typically, these torque transmitting apparatuses are constructed of a single material and have a high density. The use of a single material with a high density can result in high production costs. Moreover, the points of engagement of such apparatuses that contact other objects during the transmission of torque receive the most wear and require a high density material or high lubricity material to resist the wearing process, leading to the entire apparatus having a high density.

Therefore, it would be advantageous to employ a method for manufacturing a torque transmitting apparatus that providing a body member and then sintering an outer member that can be formed from a compacted powder metal material around the body member such that the outer member shrinks tightly around the body member to form the apparatus. Such an apparatus can provide a lightweight body member made of a lower density material while the outer member can be made of a high density powder metal with an enhanced wear resistance that can prolong the life of the apparatus.

### SUMMARY

According to one aspect, an annular outer member can fixedly engage an annular body member about the outer circumference of the annular body member. The annular outer member can be constructed of a powder metal material. The annular outer member can shrink during a sintering process to fixedly engage the annular body member.

Methods are also provided for making torque transmitting apparatuses. The methods generally comprise providing an annular body member. The methods can further comprise providing a powder metal material that can be pressed into a green compact that is substantially annular. The green compact can be positioned about the annular body member. The methods can further comprise heating the green compact and annular body together such that the substantially annular green compact can fixedly shrink around the annular body member to form a torque transmitting apparatus.

It is therefore an object of the present disclosure to provide dual metal torque transmitting apparatuses and methods for making the same such that the apparatuses provide better wear resistance and the methods are cost efficient.

An object having been stated hereinabove, and which is achieved in whole or in part by the subject matter disclosed herein, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures in which:

FIG. 1 illustrates a side elevation view of a torque transmitting apparatus provided in accordance with the subject matter disclosed herein;

FIG. 2 illustrates a side elevation view of a torque transmitting apparatus having a toothed portion in accordance with the subject matter disclosed herein;

FIG. 3 illustrates a side perspective view of the torque transmitting apparatus according to FIG. 1;

FIG. 4 illustrates a side perspective view of the torque transmitting apparatus according to FIG. 2;

FIG. 5 illustrates a cross-sectional side view of an embodiment of the torque transmitting apparatus according to FIGS. 1 and 3;

FIG. 6 illustrates a cross-sectional side view of an embodiment of the torque transmitting apparatus according to FIGS. 2 and 4;

FIG. 7 illustrates a flow chart of a method for constructing a torque transmitting apparatus in accordance with one aspect of the subject matter disclosed herein;

FIG. 8 illustrates an aspect of the present disclosure in which a sintering step facilitates construction of the torque transmitting apparatus according to FIGS. 1 and 3; and

FIG. 9 illustrates an aspect of the present disclosure in which a sintering step facilitates construction of the torque transmitting apparatus according to FIGS. 2 and 4.

### DETAILED DESCRIPTION

Reference will now be made in detail to presently preferred embodiments of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

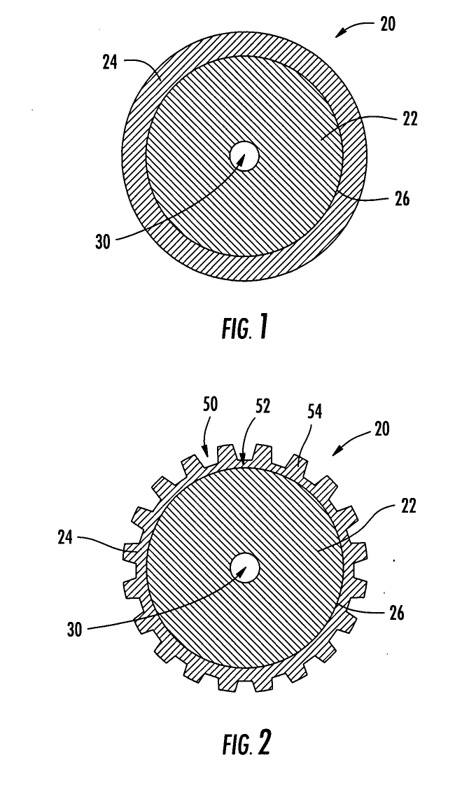

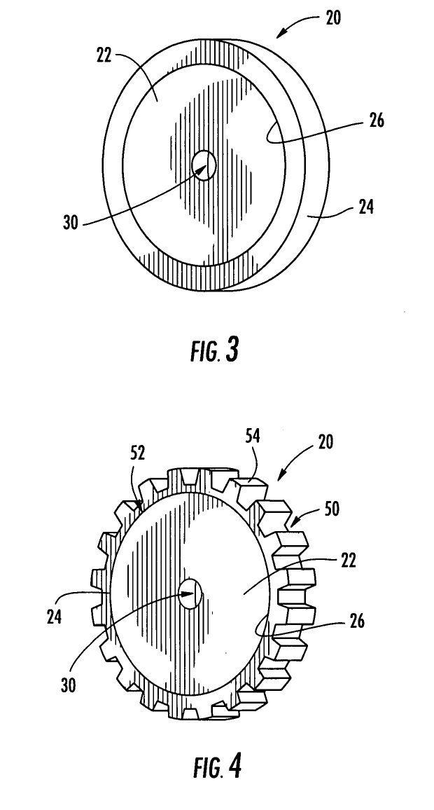

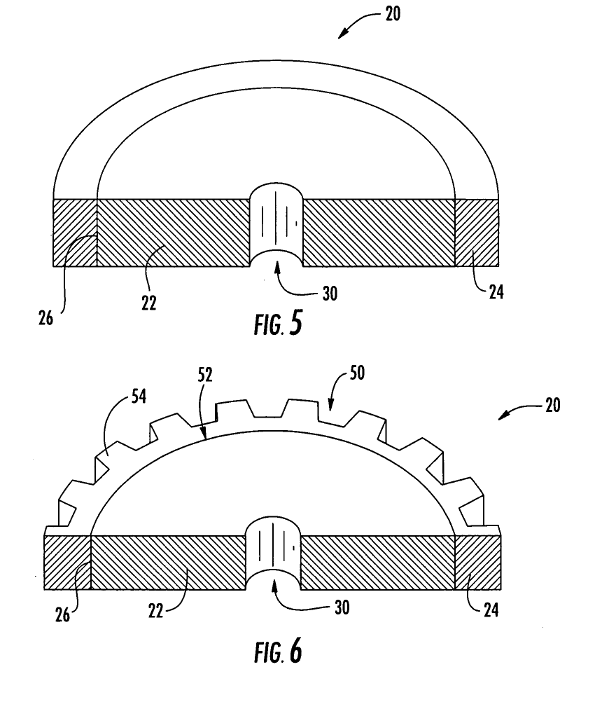

Referring now to FIGS. 1-6, a torque transmitting apparatus generally designated 20 can have a body member 22 and an outer member 24 that can be fixedly secured and engaged at an interface 26. Apparatus 20 can comprise any suitable configuration for transmitting torque as generally known to persons skilled in the art or later developed. In one aspect, as shown in FIGS. 1, 3 and 5, apparatus 20 can be substantially annular such that body member 22 and outer member 24 can be at least substantially annular. In another aspect, as illustrated in FIGS. 2, 4 and 6, apparatus 20 can be at least substantially annular with a teeth portion 50 around the outer periphery of apparatus 20 to form a gear, sprocket, or other similar structure for transmitting torque. Body member 22 and outer member 24 can be formed from dissimilar materials. In one aspect, body member 22 can be formed from an iron metal powder and outer member 24 can be formed from a bronze metal powder. In such aspects, apparatus 20 can be constructed using powder metallurgy processes that can include die compaction and sintering, as discussed further below. In other aspects, body member 22 can be formed by a casting process and then machined to any suitable shape or size. In other aspects, body member 22 can be formed of any material and by any process as known to those of skill in the art.

Body member 22 can be substantially annular or any other suitable shape for transmitting torque. Body member 22 can have an inner circumference that can define an aperture generally designated 30 for reducing the overall weight of apparatus 20 or for receiving other elements during use. In one aspect, aperture 30 can receive a driven member such as a shaft for rotating body member 22. If desired, body member 22 can include a turn-key notched portion (not shown) along its inner circumference to facilitate the transmission of torque from a shaft. Body member 22 can be a composition of iron, iron alloy, or any other suitable material that can withstand the stress and strain inherent with transmitting torque. In one aspect, the starting material for body member 22 can be a powder metal alloy as used in powder metallurgical processes. In other aspects, body member 22 can be constructed by a casting process and then machined to a desirable shape or size. To lower the costs and weight of apparatus 20, body member 22 can be a low density, low performance alloy.

Outer member 24 can be at least substantially annular or of any other suitable shape for transmitting torque. In one aspect, shown in FIGS. 1, 3 and 5, outer member 24 can be at least substantially continuous around its outer circumferential periphery for engaging other mechanical members and transmitting torque in a frictional manner. Outer member 24 can be of any thickness suitable for functioning in the manner needed. In other aspects, shown in FIGS. 2, 4 and 6, outer member 24 can include a teeth portion generally designated 50 having a root generally designated 52 and teeth 54. The periodicity of teeth 54 about the outer circumference of outer member 24 can be configured for any suitable need. Root 52 can define a root circle that follows the path of the base of teeth 54 circumferentially around the central axis of apparatus 20. The distance between the root circle and interface 26 (i.e., the thickness of root 52) can vary depending on the required strength needed by teeth portion 50 to transmit torque, but the distance therebetween can be substantially constant around apparatus 20. Teeth 54 can be of any suitable size and shape needed to perform their requisite functions.

Outer member 24 can be a composition of bronze, copper alloy or any other suitable material for withstanding the rigors and wear associated with transmitting torque, as outer member 24 will sustain the bulk of the forces involved with transmitting torque. In aspects where teeth portion 50 is present, a high density and high performance alloy can be used to provide the necessary functions. The starting material for outer member 24 can be a powder metal alloy as used in powder metallurgical processes.

The manufacture of apparatus 20 can include novel methods involving powder metallurgy, which include die compaction and sintering processes. In one aspect, apparatus 20 can be composed of dissimilar materials such that body member 22 can be formed from a first powder metal material and outer member 24 can be formed from a second powder metal material. For example, body member 22 can be formed from an iron powder metal alloy and outer member 24 can be formed from a bronze powder metal alloy. Powder metallurgy can be used to form body member 22 and outer member 24 because a powder metallurgy process can provide better precision and endurance characteristics to apparatus 20. In other aspects, body member 22 can be formed by a casting and machining process, while outer member 24 employs powder metallurgy techniques for shrinking outer member 24 around body member 22.

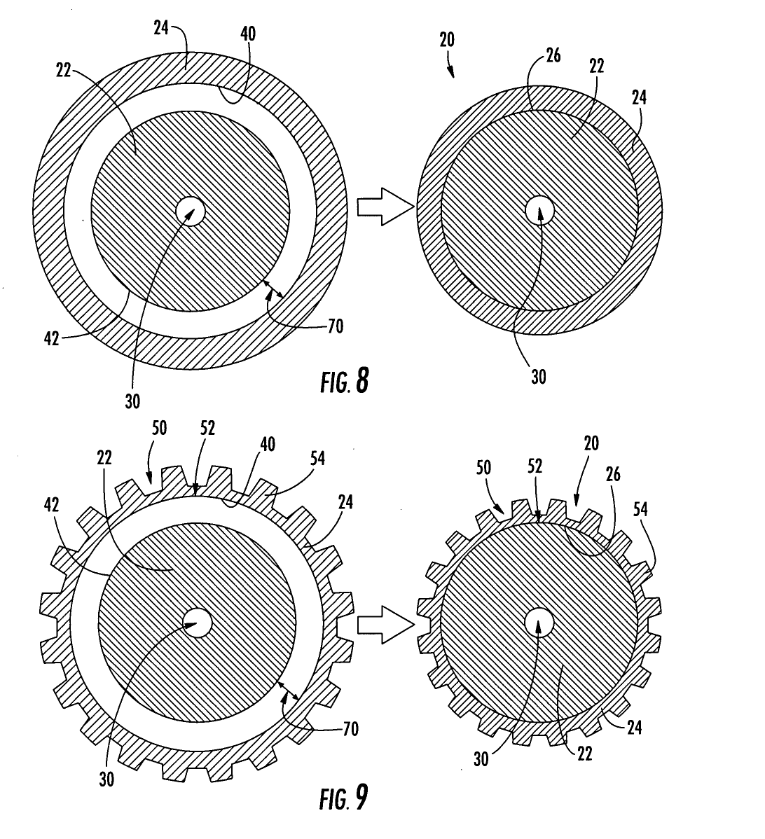

Referring now to FIGS. 8 and 9, apparatus 20 can be formed by shrinking outer member 24 around body member 22. Body member 22 can be formed by compacting a powder metal material, such as iron, into a predetermined shape such as the annular shape shown in FIGS. 8 and 9. The powder metal material can be combined with a pressing lubricant as known in the art. The powder metal material can be fed into a compaction die where the powder metal material can be pressed at a predetermined pressure that results in a green compact having a desired density for body member 22. The green compact can be removed from the compaction die. A low density green compact can be desirable for lowering the overall weight of apparatus 20. In other aspects, body member 22 can be a made by a casting and machining process or any other process known to those of skill in the art for constructing body member 22.

When forming body member 22 via powder metallurgy, a thermal treatment known as sintering can be applied to the green compact. During sintering the green compact can be heated to a temperature slightly above the melting point of the powder metal material such that the powder particles in the green compact begin to diffuse and form a solid state object upon cooling. If the temperature is elevated at a temperature high above the melting point of the powder metal material then the green compact will transition into an undesirable liquid state, thereby melting and undesirably having no shape.

Outer member 24 can be formed by pressing a powder metal material, such as bronze due to its lubricity characteristics, into a predetermined shape such as the annular shape shown in FIGS. 1, 3, 5 and 8 or the toothed shape shown in FIGS. 2, 4, 6 and 9. The powder metal material can be combined with a pressing lubricant for promoting adhesion to keep the pressed powder intact, as known in the art. The powder metal material can be fed into a compaction die such that the powder metal material can be pressed at a predetermined pressure, resulting in a green compact having a desired density for outer member 24. A high density is desirable due to the wear this portion of apparatus 20 can encounter. The green compact can be removed from the compaction die. Additionally, the compaction die can be shaped so as to provide a teeth shape to the outer periphery of outer member 24.

The inner circumference of outer member 24 can have a diameter larger than the diameter of the outer circumference of body member 22. Outer member 24 can be positioned around body member 22, as shown in FIGS. 8 and 9. Body member 22 can be, as this point, a sintered or cast and machined solid object while outer member 24 can be a green compact object that has yet to be thermally treated. A gap generally designated 70 can exist between an inner rim 40 of outer member 24 and an outer rim 42 of body member 22. The gap can be of any distance or shape suitable provided that outer member 24 can fixedly bond to body member 22 upon shrinking.

Body member 22 and outer member 24 can be thermally treated at a temperature such that the green (non-sintered) compact of outer member 24 is sintered. This temperature can be much lower than the temperature at which body member 22 was sintered in aspects where body member 22 is constructed via a sintering process. During the sintering process, the particles of outer member 24 begin to diffuse and bond to form a solid object upon cooling. As this occurs, outer member 24 can shrink such that the inner circumference and diameter of outer member 24 become smaller. Outer member 24 can shrink such that gap 70 can be eliminated and outer member 24 can fixedly surround body member 22. Outer member 24 can be tightly fitted to body member 22 to form a primary bond such that the two members cannot rotate with respect to each other and can mechanically function as a single body. Outer member 24 can shrink around body member 22 in a manner such that during use the two members do not separate and remain intact as a single body or structure.

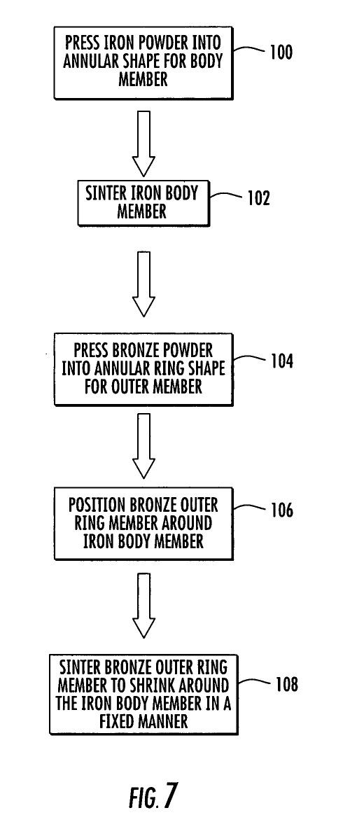

FIG. 7 is a flow chart of one aspect of a process that can be used for making apparatus 20 according to aspects of the subject matter described herein. In other aspects not shown in FIG. 7, body member 22 can be formed through a casting and machining process or any other suitable process as know by those of skill in the art. Referring to FIG. 7, in block 100, body member 22 can be composed of an iron powder metal that can be pressed into an annular shaped body. In block 102, the iron body can then be sintered at a temperature of approximately 2100° F. Following, in block 104, outer member 22 can be composed of a bronze powder metal that is pressed into an annular shaped outer ring. In block 106, the bronze ring can be positioned around the iron body such that gap 70 (FIGS. 8 and 9) exists therebetween. In block 108, the iron body and bronze ring can then be heated to a temperature of approximately 1550° F. in an oven such that the bronze ring undergoes a sintering process that shrinks the bronze ring tightly around the iron body. This temperature is well below the melting temperature of iron and therefore has no detrimental mechanical or functional effects on the iron body.

With continuing reference to FIG. 7, in this aspect the iron metal does not have a significant level of diffusion into the bronze metal and vice versa. Some localized diffusion may occur, but this is not the primary bonding method. As mentioned above, the temperatures used in this process can be sintering temperatures that are slightly above the melting temperatures of the respective materials. The two temperatures used in this aspect can vary substantially and thus the iron body never reaches a temperature at which significant amounts of diffusion can occur between the two materials when they come into contact during shrinking of the bronze ring. During the step of block 108, in which the outer member can shrink around the body member, the body member can remain in a solid phase while the outer member is in a sintering phase in which diffusion of particles within the outer member will occur, but diffusion into the body material does not occur to any significant depth. Therefore, there can be a distinct interface 26 between the material composing body member 22 and outer member 24.

With further reference to FIG. 7, the sintering of the bronze ring can occur after the sintering of the iron body, since if the iron body is sintered at the same time as the bronze ring, then the bronze ring can transition from a solid phase material to a liquid phase material having no shape. In other words, if the process were one-step in which both pressed materials were simultaneously sintered, then the bronze material would melt because a temperature much higher than its melting temperature is required to sinter the iron material. Also, if the bronze ring were first sintered to shrink around the pressed iron body before the iron was sintered, then upon sintering of the iron body at a temperature much higher than the melting temperature of bronze, the bronze material would again transition into a liquid phase and undesirably lose its shape. This is due to the substantially differing melting points of the two materials. Thus, a two-step sintering process can be used in this particular aspect. Materials with similar sintering temperatures can be sintered simultaneously such that the outer ring shrinks around the body, while both materials and members undergo a sintering process that transforms the particulate compacts into a solid torque transmitting apparatus.

In other aspects, body member 22 can be cast and machined from an iron or iron alloy material. Outer member 24 can be composed of a bronze or copper alloy powder metal that can be pressed into an annular shaped outer ring. Outer member 24 can be positioned around body member 22 such that gap 70 (FIGS. 8 and 9) exists therebetween. Body member 22 and outer member 24 can then be heated such that outer member 24 undergoes a sintering process that shrinks the outer member 24 tightly around body member 22 to form a primary bond.

It will be understood that various details of the disclosed subject matter may be changed without departing from the scope of the disclosed subject matter. Furthermore, the foregoing description is for the purpose of illustration only, and not for the purpose of limitation.

What is claimed is:

1. A torque transmitting apparatus comprising:
a body member having an outer rim;
an outer member adjacent to and substantially surrounding the outer rim of the body member, the outer member constructed from a powder metal material shrunk onto the body member to fixedly engage the body member.

2. The torque transmitting apparatus of claim 1 wherein the body member is substantially annular.

3. The torque transmitting apparatus of claim 1 wherein the outer member is substantially annular.

4. The torque transmitting apparatus of claim 1 wherein the body member is constructed from a second powder metal material.

5. The torque transmitting apparatus of claim 4 wherein the second powder metal material is iron or iron alloy.

6. The torque transmitting apparatus of claim 1 wherein the powder metal material is bronze or copper alloy.

7. The torque transmitting apparatus of claim 1 wherein the apparatus is a gear.

8. The torque transmitting apparatus of claim 1 wherein the outer member is configured to have a teeth portion.

9. A method for making a torque transmitting apparatus comprising:
compacting a first powder metal material into a first green compact being substantially annular;
compacting a second powder metal material into a second green compact being substantially annular;
heating the second green compact at a first temperature to sinter the second green compact to form an annular body member;
positioning the first green compact about the annular body member; and
heating the first green compact and annular body together at a second temperature such that the substantially annular first green compact is sintered, whereby the first green compact shrinks around the annular body member.

10. The method according to claim 9 wherein the first powder metal material is bronze or copper alloy.

11. The method according to claim 9 wherein the second powder metal material is iron or iron alloy.

12. The method according to claim 9 wherein the first green compact is configured to have a tooth portion about its circumference.

13. A method for making a torque transmitting apparatus comprising:
positioning a powder metal outer member substantially about a body member; and
heating the powder metal outer member and body member such that the powder metal outer member is sintered, whereby the powder metal outer member shrinks about the body member to fixedly engage the body member.

14. The method according to claim 13 wherein the powder metal outer member is bronze or copper alloy.

15. The method according to claim 13 wherein the body member is constructed from a second powder metal material.

16. The method according to claim 15 wherein the second powder metal material is iron or iron alloy.

17. A torque transmitting apparatus made by the steps of:
providing a body member;
positioning an outer member about the body member; and
heating the outer member and body member together such that the outer member undergoes a sintering process and thereby shrinks around the body member.

18. The apparatus of claim 17 wherein the apparatus is a gear.

19. The apparatus of claim 17 wherein the body member is iron or iron alloy.

20. The apparatus of claim 19 wherein the outer member is bronze or copper alloy powder metal material.
